(19) United States
(12) Patent Application Publication
(10) Pub. No.: US 2023/0113538 A1
(43) Pub. Date: Apr. 13, 2023

(54) MUSCLE BLOCKS AND INJECTION TRAINERS INCLUDING A MUSCLE BLOCK

(71) Applicant: Regeneron Pharmaceuticals, Inc., Tarrytown, NY (US)

(72) Inventors: Jonathan LAFOLLETTE, East Greenbush, NY (US); Christopher HUNTER, Castleton-on-Hudson, NY (US)

(73) Assignee: Regeneron Pharmaceuticals, Inc., Tarrytown, NY (US)

(21) Appl. No.: 18/045,603

(22) Filed: Oct. 11, 2022

Related U.S. Application Data
(60) Provisional application No. 63/255,151, filed on Oct. 13, 2021.

(51) Int. Cl. G09B 23/28; B32B 3/12; B32B 5/18; B32B 27/40; B32B 25/04; B32B 25/08; B32B 1/00

(52) U.S. Cl. CPC G09B 23/285; B32B 3/12; B32B 5/18; B32B 27/40; B32B 25/045; B32B 25/08; B32B 1/00; B32B 2535/00; B32B 2266/0207

(57) ABSTRACT

An injection trainer may comprise a muscle block, a surface layer, and an intermediate between the muscle block and the surface layer. The muscle block may include one or more regions comprising an arrangement of fill material defined by a repeating unit cell. The muscle block may provide sufficient back pressure to actuate an injector. The surface layer and/or intermediate layer may provide realistic feeling tissue that a use may pinch during the injection process.

### CROSS-REFERENCE TO RELATED APPLICATIONS

This application claims priority to U.S. Provisional Patent Application No. 63/255,151, filed Oct. 13, 2021, which is hereby incorporated by reference in its entirety.

### TECHNICAL FIELD

This disclosure is directed to tissue analogs including muscle blocks and injection trainers comprising a muscle block.

### INTRODUCTION

Injectors for delivering medicament into tissue can be more effective when users are familiarized with the injectors by using tissue analogs, or trainers for the injector including a tissue analog. Additionally, having a uniform injection target can improve the reliability and repeatability of studies and investigations relating to the function and efficacy of injectors. Many currently available tissue analogs and injection trainers have difficulties mimicking surface tissues, subcutaneous tissues, and the back pressure provided by muscle tissue. Further, some tissue analogs and injections trainers are not configured to receive injections, and require a mock or dummy injector, as part of the training process. Differences in the injection process between training and real-use scenarios can result in less effective training, and can compromise the intended familiarization of the injector with the user.

### SUMMARY OF THE DISCLOSURE

Aspects of the present disclosure relate to muscle blocks and injection trainers including a muscle block. In one aspect, a muscle block includes a plurality of first layers and a plurality of second layers. Each first layer of the plurality of first layers comprises an arrangement of fill material defined by a first unit cell repeating in two dimensions within a plane. Each second layer of the plurality of second layers comprises an arrangement of fill material defined by a second unit cell repeating in two dimensions within a plane. The first unit cell may include a doubly periodic or triply periodic arrangement of fill material. The second unit cell may include a doubly periodic or triply periodic arrangement of fill material.

The first unit cell may include a triply periodic arrangement of fill material including a gyroid shape. The second unit cell may be identical to the first unit cell. The muscle block may have a general geometry including a half cylinder. The fill material may comprise polylactic acid, polypropylene, polyethylene terephthalate, acrylonitrile butadiene styrene polymers, acrylic styrene acrylonitrile polymers, poly(methyl methacrylate), polyoxymethylene, polyetherimide, one or more other thermoplastic polymers, or other material capable of being used in an additive printing application. The Shore hardness of the fill material may be approximately 70 A to approximately 90 A. The average density of the muscle block may be approximately 10% infill to approximately 25% infill. The first unit cell may be a cubic unit cell and may have a length have approximately 4 (millimeters) mm to approximately 12 mm. The muscle block may comprise tubules with a minimum diameter of approximately 2 mm to approximately 8 mm.

In another aspect, an injection trainer includes a muscle block and one or more overlying layers above the muscle block. A region of the muscle block may comprise an arrangement of fill material defined by a unit cell repeating in three dimensions.

The one or more overlying layers may be designed to allow a user to simulate a skin pinch. The one or more overlying layers may comprise an intermediate layer and a surface layer. The intermediate layer may comprise a foam rubber, a polyurethane, or a sponge. The surface layer may comprise a silicone rubber, an ethylene propylene rubber, a fluoroelastomer, an olefin-based rubber, a latex rubber, a nitrile rubber, or a butyl rubber. The fill material may comprise polylactic acid, polypropylene, polyethylene terephthalate, acrylonitrile butadiene styrene polymers, acrylic styrene acrylonitrile polymers, poly(methyl methacrylate), polyoxymethylene, polyetherimide, one or more other thermoplastic polymers, or other material capable of being used in an additive printing application, and have a Shore hardness of approximately 70 A to approximately 90 A. The region of the muscle block comprising an arrangement of fill material defined by a unit cell repeating in three dimensions may constitute at least 80% of the total volume of the muscle block.

In another aspect, an injection trainer includes a muscle block, a surface layer, and an intermediate layer between the muscle block and the surface layer. The muscle block may comprise a material with a Shore hardness of approximately 70 A to approximately 90 A. The surface layer may comprise a silicone rubber, an ethylene propylene rubber, a fluoroelastomer, an olefin-based rubber, a latex rubber, a nitrile rubber, or a butyl rubber. The muscle block may include a region comprising an arrangement of fill material defined by a first unit cell repeating in three dimensions, and the unit cell may have a density of at least approximately 10% infill.

The intermediate layer may contact the muscle block and the surface layer, and the intermediate layer may comprise a foam rubber, a polyurethane, or a sponge. The combined thicknesses of the surface layer and the intermediate layer may be less than or equal to the height of the muscle block. The injection trainer may further include a slot.

### BRIEF DESCRIPTION OF THE FIGURES

The accompanying drawings, which are incorporated in and constitute a part of this specification, illustrate various examples and together with the description, serve to explain the principles of the disclosed examples and embodiments.

Aspects of the disclosure may be implemented in connection with embodiments illustrated in the attached drawings. These drawings show different aspects of the present disclosure and, where appropriate, reference numerals illustrating like structures, components, materials, and/or elements in different figures are labeled similarly. It is understood that various combinations of the structures, components, and/or elements, other than those specifically shown, are contemplated and are within the scope of the present disclosure.

Moreover, there are many embodiments described and illustrated herein. The present disclosure is neither limited to any single aspect nor embodiment thereof, nor to any combinations and/or permutations of such aspects and/or embodiments. Moreover, each of the aspects of the present disclosure, and/or embodiments thereof, may be employed alone or in combination with one or more of the other aspects of the present disclosure and/or embodiments thereof. For the sake of brevity, certain permutations and combinations are not discussed and/or illustrated separately herein. Notably, an embodiment or implementation described herein as “exemplary” is not to be construed as preferred or advantageous, for example, over other embodiments or implementations; rather, it is intended reflect or indicate the embodiment(s) is/are “example” embodiment(s).

FIG. 1A is a perspective view of an injection trainer, according to one or more embodiments;

FIG. 1B is a front view of the injection trainer shown in FIG. 1A;

FIG. 1C is a side view of the injection trainer shown in FIGS. 1A and 1B;

FIG. 1D is a bottom view of the injection trainer shown in FIGS. 1A, 1B, and 1C;

FIG. 2 is a plan view of a fastening strap, according to one or more embodiments;

FIG. 3A is a perspective view of an injection trainer, according to one or more embodiments;

FIG. 3B is a front view of the injection trainer shown in FIG. 3A;

FIG. 3C is a side view of the injection trainer shown in FIGS. 3A and 3B;

FIG. 3D is a bottom view of the injection trainer shown in FIGS. 3A, 3B, and 3C;

FIG. 4A is a perspective view of a base plate, according to one or more embodiments;

FIG. 4B is a side view of the base plate shown in FIG. 4A;

FIG. 4C is a top view of the base plate shown in FIGS. 4A and 4B;

FIG. 5A is a perspective view of an injection trainer, according to one or more embodiments;

FIG. 5B is a front view of the injection trainer shown in FIG. 5A;

FIG. 5C is a side view of the injection trainer shown in FIGS. 5A and 5B;

FIG. 6A is a perspective view of a muscle block, according to one or more embodiments;

FIG. 6B is a front view of the muscle block shown in FIG. 6A;

FIG. 6C is a side view of the muscle block shown in FIGS. 6A and 6B;

FIG. 6D is a perspective view of the bottom of the muscle block shown in FIGS. 6A, 6B, and 6C;

FIG. 7A is a perspective view of a muscle block unit cell, according to one or more embodiments;

FIG. 7B is a front view of the muscle block unit cell shown in FIG. 7A;

FIG. 7C is a side view of the muscle block unit cell shown in FIGS. 7A and 7B;

FIG. 7D is a top view of the muscle block unit cell shown in FIGS. 7A, 7B, and 7C;

FIG. 8A is a perspective view of a muscle block layer, according to one or more embodiments;

FIG. 8B is a front view of the muscle block layer shown in FIG. 8A;

FIG. 8C is a side view of the muscle block layer shown in FIGS. 8A and 8B;

FIG. 8D is a top view of the muscle block layer shown in FIGS. 8A, 8B, and 8C;

FIG. 9A is a perspective view of a region of a muscle block, according to one or more embodiments;

FIG. 9B is a front view of the muscle block region shown in FIG. 9A;

FIG. 9C is a side view of the muscle block region shown in FIGS. 9A and 9B;

FIG. 9D is a top view of the muscle block region shown in FIGS. 9A, 9B, and 9C;

FIG. 10A is a perspective view of a region of a muscle block, according to one or more embodiments;

FIG. 10B is a front view of the muscle block region shown in FIG. 10A;

FIG. 10C is a side view of the muscle block region shown in FIGS. 10A and 10B; and

FIG. 10D is a top view of the muscle block region shown in FIGS. 10A, 10B, and 10C.

Again, there are many embodiments described and illustrated herein. The present disclosure is neither limited to any single aspect nor embodiment thereof, nor to any combinations and/or permutations of such aspects and/or embodiments. Each of the aspects of the present disclosure, and/or embodiments thereof, may be employed alone or in combination with one or more of the other aspects of the present disclosure and/or embodiments thereof. For the sake of brevity, many of those combinations and permutations are not discussed separately herein.

Notably, for simplicity and clarity of illustration, certain aspects of the figures depict the general structure and/or manner of construction of the various embodiments. Descriptions and details of well-known features and techniques may be omitted to avoid unnecessarily obscuring other features. Elements in the figures are not necessarily drawn to scale; the dimensions of some features may be exaggerated relative to other elements to improve understanding of the example embodiments.

### DETAILED DESCRIPTION

Reference will now be made in detail to examples of the present disclosure, which are illustrated in the accompanying drawings. Wherever possible, the same reference numbers will be used throughout the drawings to refer to the same or like parts. In the discussion that follows, relative terms such as “about,” “substantially,” “approximately,” etc. are used to indicate a possible variation of ±10% in a stated numeric value.

As described above, injectors (e.g., auto-injectors) can be more effective when users are familiarized with the injectors by using a trainer for the injector. Trainers that feel consistent with the target tissue and exhibit physical properties similar to the target tissue are most effective. For example, trainers that are too hard or too soft, may result in a user not realizing the proper force necessary for applying the injector in a real-use scenario.

Some injectors require a user to forcefully push the injector against the injection recipient's tissue (e.g., a leg muscle), in order to trigger the injector and have the injector deliver a load (e.g., medicament or another fluid). Trainers for injectors that do not provide an accurate muscle analog can fail to provide the sufficient back pressure to trigger the injector when a user applies a force to trigger the injector that varies from the optimal or intended application. For example, if a user applies the injector too forcefully, the trainer may deform more than intended and fail to provide sufficient back pressure to trigger the injector. Effective trainers for injectors should cause the injector to activate even if the force applied by the user varies from the optimal application (e.g., the force applied is greater than the force intended to activate the injector). Additionally, effective injection trainers allow a user to simulate pinching of tissue (e.g., skin or subcutaneous tissue).

Injection trainers are most effective when they allow a user to actually deliver an injection material (e.g., medicament or other fluid). For injection trainers that allow a user to deliver an injection material, it is desirable that the injection trainer can be available for multiple uses. To that end, some injection trainers may be easily washed or otherwise cleaned, to allow for repeat uses. In other cases, an injection trainer may be configured to collect or otherwise absorb injected medicament such that multiple injections may be made in a single trainer.

The injection trainers and muscle blocks described herein may fulfill the criteria of an effective injection trainer and/or tissue analog. The injection trainers provide sufficient back-pressure to activate an auto-injector, even if the force applied by the user varies from the intended application of the injector. Additionally, the injection trainers allow users to simulate a skin pinch during the injection process. Further, the injection trainers and muscle blocks include space (e.g., channels) that allow for injection liquid to pass into and through the injection trainer. The injection trainers described herein include materials that allow for efficient and expedient washing and/or cleaning of the trainer between injections.

Injection trainers and muscle blocks may be used in investigations and studies into the effectiveness and design of injectors. The injection trainers and muscle blocks of the present disclosure may provide a uniform injection target, suitable for the development and evaluation of previously existing, new, or modified injectors. For example, investigations may be conducted to study potential sources of human error in the injection process, determine potential inefficiencies in injector design, and/or develop new injector designs. In such investigations, it may be beneficial to have a uniform injection target, and/or a target that responds consistently to external force, regardless of the direction of the force. The injection trainers and muscle blocks described herein are designed to respond consistently to external force, regardless of the direction of the force, thereby providing a more uniform injection target to multiple users. A uniform response from the injection trainer, reduces the sources of error present and allows for more meaningful and precise data collection.

Examples of injectors that may be used with the embodiments disclosed herein may include those described in U.S. Provisional Application No. 63/134,554; U.S. Design application No. 29/760,798; U.S. Pat. No. 10,182,969; U.S. Patent Pub. 2020/0086051; U.S. Patent Pub. 2020/0306453; WIPO Publication WO2020/247686; and WIPO Publication WO2021/003409, the each of which are incorporated by reference herein, in their entirety.

Injection Trainer

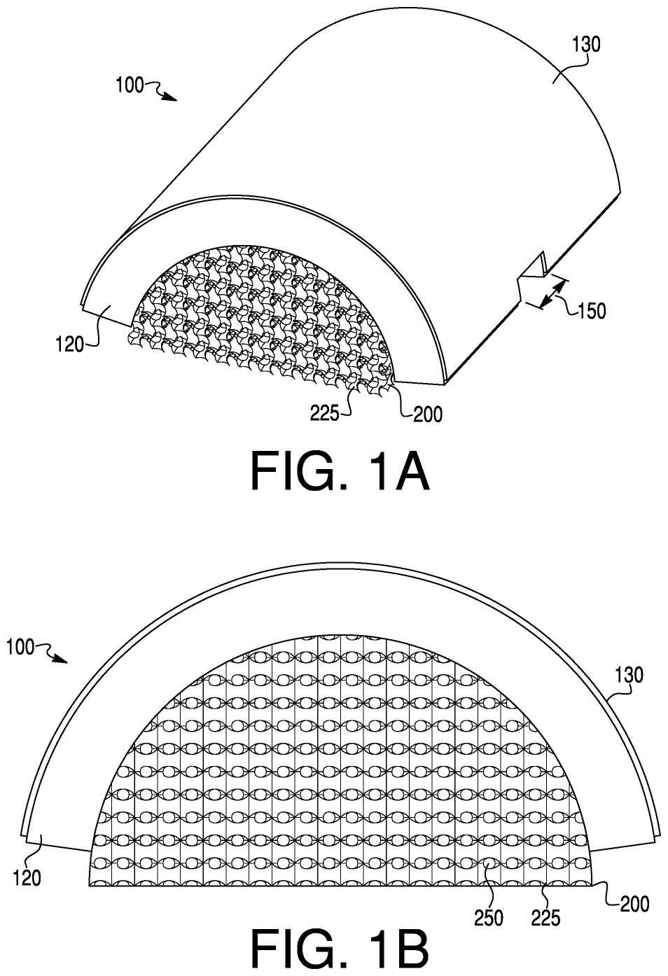

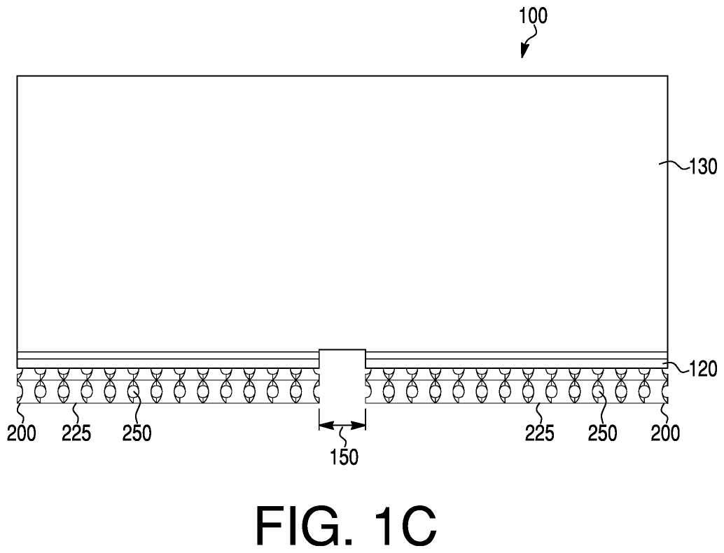

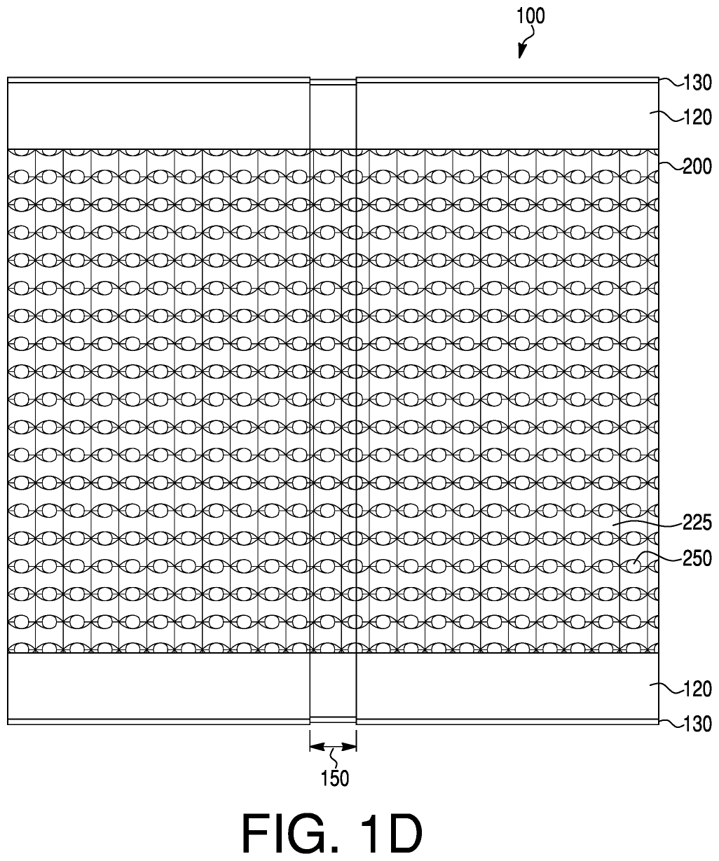

An injection trainer may include a muscle block and one or more layers above the muscle block (e.g., a surface layer, an intermediate layer, a skin simulating layer, a subcutaneous tissue simulating layer). The structure of the muscle block may prevent occlusion and/or coring of the injector (e.g., a needle or other medicament delivery component of the injector). The muscle block is also structured to be permeable to injected liquids, and respond isotopically to an applied external force. Referring to FIGS. 1A-1D, an injection trainer 100 may include a muscle block 200, an intermediate layer 120, and a surface layer 130.

The injection trainer 100 may include an intermediate layer 120 above and in contact with the muscle block 200. For example, an inner surface (e.g., the bottom surface) of intermediate layer 120 may be in contact with a top surface (e.g., a curved top surface) of muscle block 200. Injection trainer 100 may also include a surface layer 130 positioned above intermediate layer 120. For example, an inner surface of surface layer 130 may be in contact with an outer surface of intermediate layer 120, wherein the outer surface of intermediate layer 120 is opposite the inner surface of intermediate layer 120.

Intermediate layer 120 may comprise a foam rubber, polyurethane, a sponge, or other deformable material. Intermediate layer 120 may be porous and allows for medicament introduced by the injector to pass through intermediate layer 120 to muscle block 200. In addition, or alternatively, injection trainer 100 may be configured so that, when delivering medicament, a needle or outlet of the injector extends through intermediate layer 120, such that medicament is dispensed directly to muscle block 200. Injection trainer 100 may function as a trainer for subcutaneous and/or dermal injections. When used as a trainer for subcutaneous and/or dermal injections, in the event a user over-inserts the injector (e.g., accidentally sticks positions the injector in muscle block 200), the structure of muscle block 200 prevents coring and occlusion of the injector, and allows for medicament to pass through the muscle block 200.

Surface layer 130 may comprise an elastomer, such as, for example, a silicone rubber, an ethylene propylene rubber, a fluoroelastomer, an olefin-based rubber, a latex rubber, a nitrile rubber, a butyl rubber, or other elastic material. In some embodiments, surface layer 130 comprises a material than can be pierced by a needle or other outlet of the injector. Surface layer 130 may be thin enough, and/or pliable enough, to ensure that the needle or outlet of the injector is able to pass from an outer surface of surface layer 130, through the thickness of surface layer 130, and out the inner surface of surface layer 130, into one or more other overlying layers (e.g., intermediate layer 120) and/or muscle block 200. In some embodiments, surface layer 130 may be hydrophobic or include a hydrophobic coating, to aid in the cleaning of surface layer 130 between injections.

During operation of injection trainer 100, surface layer 130 may act as an analog for skin tissue, and intermediate layer 120 may act as an analog for subcutaneous tissue (e.g., fat and other subdermal tissue). The dimensions and elasticity of intermediate layer 120 and surface layer 130 may allow a user to simulate a skin pinch, during operation of an injector with injection trainer 100. As previously described, the ability for a user to simulate a skin pinch during the injecting training process allows injection trainer 100 to familiarize a user with the injection process in a realistic setting.

In some embodiments, the muscle block 200 may have an approximate shape of a half-cylinder. In other embodiments, the muscle block 200 may be rectangular, trapezoidal, any shape with a generally flat surface opposite a curved surface, or any other shape that approximates human tissue. Indeed, muscle block 200 may include one or more curves or other topography for simulating any of a number of various injection sites on a human body. The other layers of the injection trainer 100 (e.g., intermediate layer 120 and surface layer 130) may conform to a top surface of muscle block 200. For example, other layers of injection trainer 100 (e.g., intermediate layer 120 and surface layer 130) may have a pre-formed curve that aligns with a curved top surface of muscle block 200. In some embodiments, intermediate layer 120 may be flexible and conform to the shape of the top surface of muscle block 200. In addition, or alternatively, surface layer 130 may be flexible and conform to the shape of the outer surface of the intermediate layer 120.

Intermediate layer 120 may have a generally rectangular cross-sectional shape. For example, intermediate layer 120 may have an inner surface (e.g., a surface in contact with muscle block 200) and an outer surface (e.g., a surface in contact with surface layer 130). The inner surface may be substantially the same size and shape as the outer surface. Intermediate layer 120 may have a thickness (i.e., distance between the inner surface and the outer surface) of approximately 5 mm to approximately 30 mm, such as, for example, approximately 5 mm to approximately 25 mm, approximately 5 mm to approximately 20 mm, approximately 5 mm to approximately 15 mm, approximately 10 mm to approximately 20 mm, approximately 10 mm to approximately 15 mm, approximately 15 mm to approximately 20 mm, or approximately 15 mm. Intermediate layer 120 may have a consistent thickness between the inner surface and the outer surface. In some embodiments, a first portion of intermediate layer 120 has a greater thickness than a second portion of intermediate layer 120.

Intermediate layer 120 may have a sufficient length and width to cover the top surface of muscle block 200. In some embodiments, the length and/or width of intermediate layer 120 may be longer or shorter than necessary to cover the top surface of muscle block 200.

In the embodiment shown in FIGS. 1A-1D, the length of intermediate layer 120 is equal to the length of muscle block 200. Accordingly, the entire length of muscle block 200 is covered by intermediate layer 120. In some embodiments, intermediate layer 120 may have a length greater than the length of the muscle block 200; in such embodiments, a portion of intermediate layer 120 extends past a front surface and/or a back surface of muscle block 200. In some instances, intermediate layer 120 may have a length shorter than the length of muscle block 200; in such instances, a portion of the top surface of muscle block 200, in front of intermediate layer 120, behind intermediate layer 120, or both, is not covered by intermediate layer 120.

In the embodiment shown in FIGS. 1A-1D, the width of intermediate layer 120 is shorter than necessary to cover the entire top surface of muscle block 200. Therefore, a portion of the height of the top surface (e.g., top curved surface) of muscle block 200 is not covered by intermediate layer 120. Stated differently, a portion of the top surface of muscle block 200 is visible below intermediate layer 120 in the side view of the injection trainer 100, shown in FIG. 1C. In other embodiments, the width of intermediate layer 120 is sufficient to cover the entire top surface of muscle block 200, so that the top surface of muscle block 200 would not be visible in a side view of injection trainer 100.

Surface layer 130 may have a generally rectangular cross-sectional shape. For example, surface layer 130 may have an inner surface (e.g., a surface in contact with intermediate layer 120) and an outer surface (e.g., a top surface of injection trainer 100). The inner surface may be substantially the same size and shape as the outer surface. Surface layer 130 may have a thickness (i.e., distance between the inner surface and the outer surface) of approximately 1.0 mm to approximately 3.0 mm, such as, for example, approximately 1.0 mm to approximately 2.5 mm, approximately 1.5 mm to approximately 2.5 mm, approximately 1.0 mm to approximately 2.0 mm, or approximately 1.5 mm to approximately 2.0 mm. In some instances, surface layer 130 may have a thickness less than or equal to 3.0 mm, as a surface layer 130 with a thickness greater than 3.0 mm may prevent the injector from properly functioning. Surface layer 130 may have a consistent thickness between the inner surface and the outer surface. In some embodiments, a first portion of surface layer 130 has a thickness greater than a thickness of a second portion of surface layer 130.

Surface layer 130 may have a sufficient length and width to cover the outer surface of intermediate layer 120. In some embodiments, the length and/or width of surface layer 130 may be longer or shorter than necessary to cover the outer surface of intermediate layer 120.

In the embodiment shown in FIGS. 1A-1D, the length of surface layer 130 is equal to the length of intermediate layer 120. Consequently, the entire length of intermediate layer 120 is covered by surface layer 130. In some embodiments, surface layer 130 may have a length greater than the length of the intermediate layer 120; in such embodiments, a portion of surface layer 130 extends past a front edge and/or a back edge of intermediate layer 120. In some instances, surface layer 130 may have a length shorter than the length of intermediate layer 120; in such instances, a portion of the outer surface of intermediate layer 120, in front of surface layer 130, behind surface layer 130, or both, is not covered by surface layer 130.

In the embodiment shown in FIGS. 1A-1D, the width of surface layer 130 is shorter than necessary to cover the outer surface of intermediate layer 120. Therefore, a portion of the width of intermediate layer 120 is not covered by surface layer 130. Stated differently, a portion of the outer surface of intermediate layer 120 is visible below surface layer 130 in the side view of the injection trainer 100 shown in FIG. 1C. In other embodiments, the width of surface layer 130 is sufficient to cover the entire width of intermediate layer 120, so that the outer surface of intermediate layer 120 would not be visible in a side view of injection trainer 100.

As described herein, intermediate layer 120 and surface layer 130 may be provided as separate structures that can be separated for cleaning. In some embodiments, injection trainer 100 includes an intermediate layer 120 and surface layer 130 provided as a single structure overlying muscle block 200. In other embodiments, injection trainer 100 includes a skin layer overlying the muscle block 200, wherein the skin layer is equivalent to the structure and function of the intermediate layers 120 and/or surface layers 130 described herein. Other combinations of overlying layers that achieve the functions and benefits of intermediate layer 120 and/or surface layer 130 may be employed in an injection trainer 100 with the muscle blocks 200 described herein.

The layers overlying the muscle block 200 (e.g., intermediate layer 120 and surface layer 130) may be joined and secured to muscle block 200 with a fastening strap, hook-and-loop fasteners, adhesive, or a combination thereof.

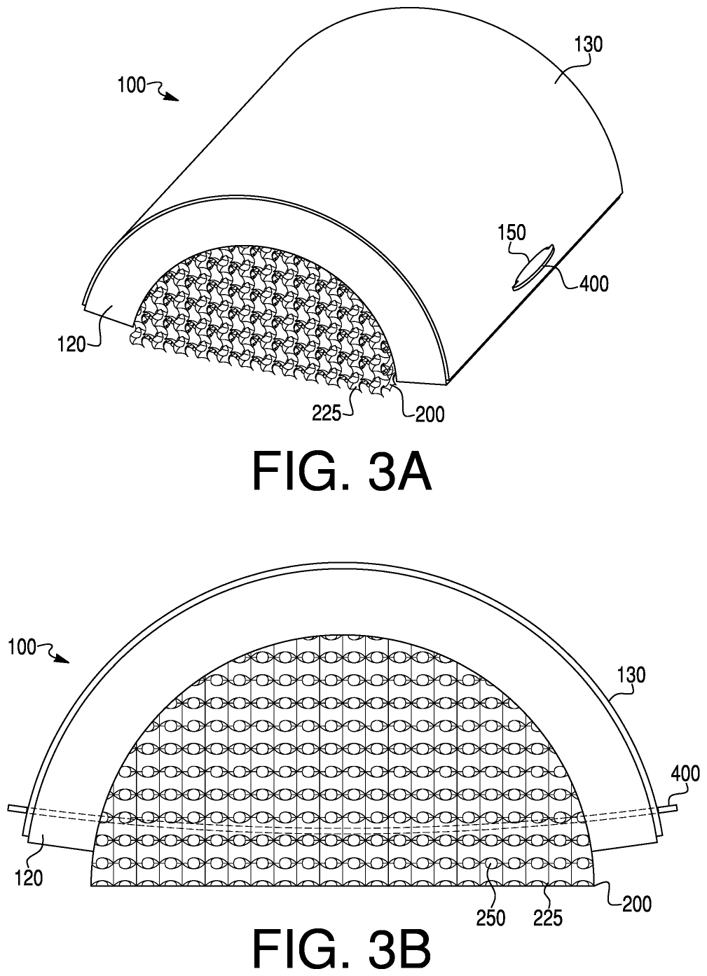

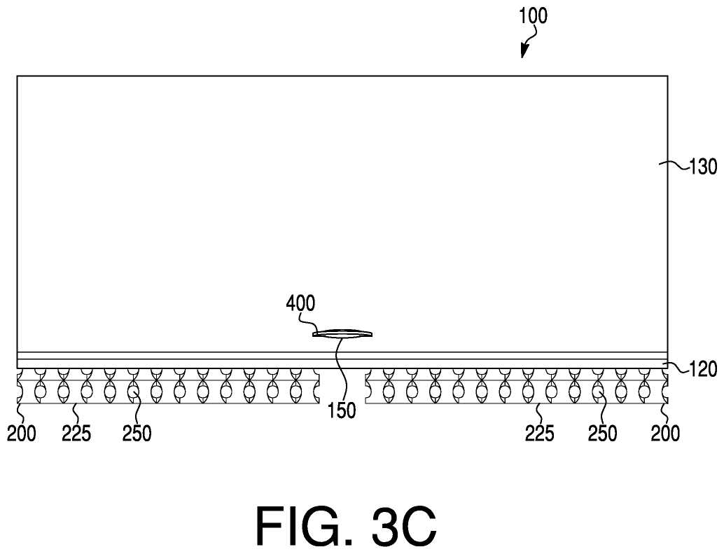

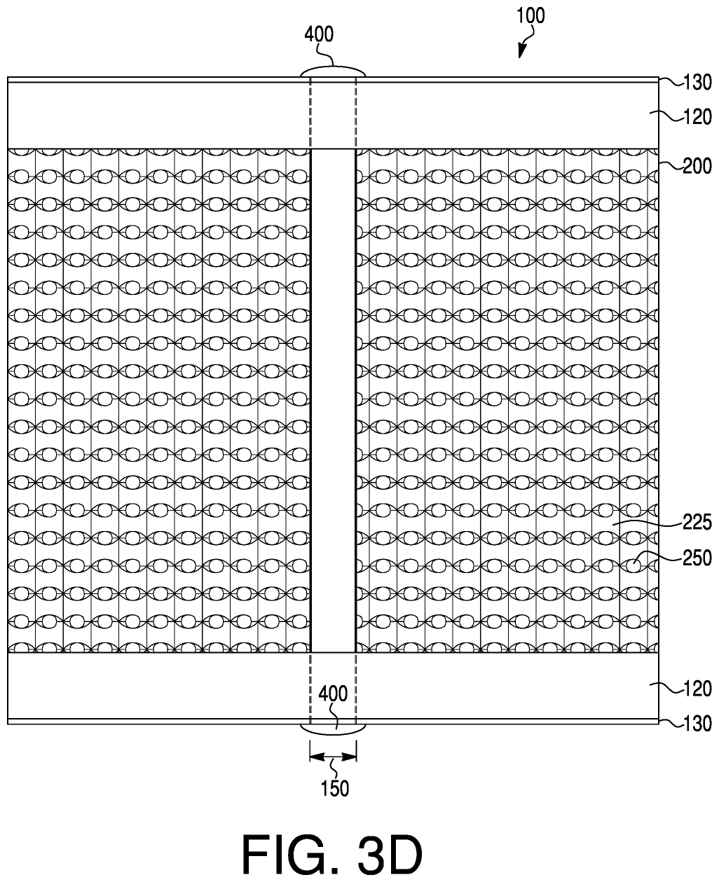

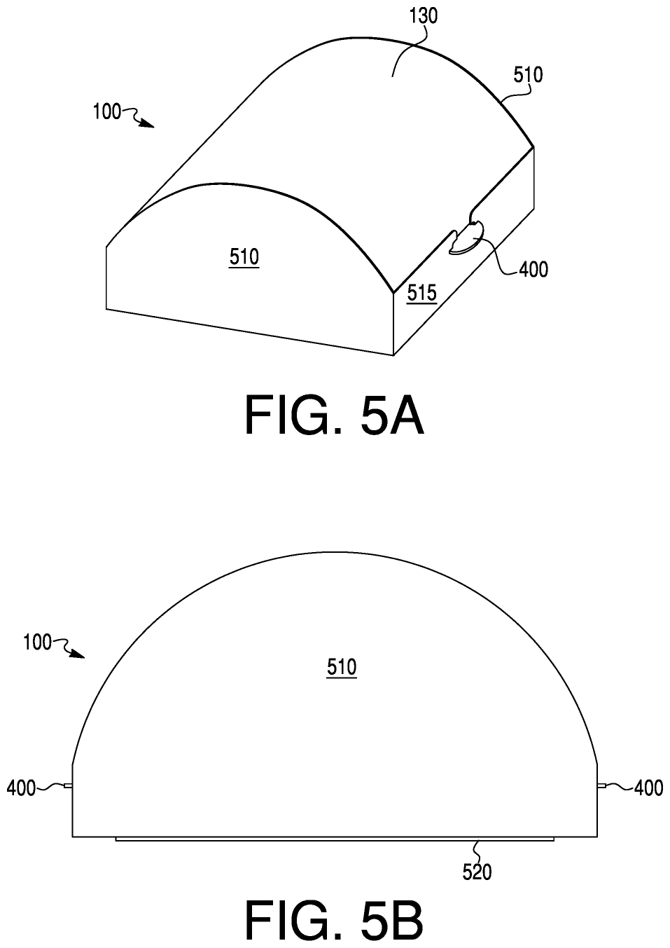

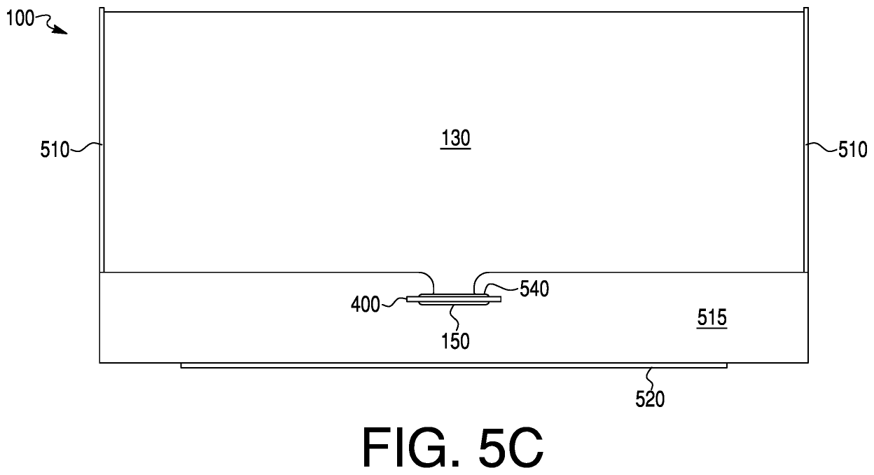

Still referring to FIGS. 1A-1D, injection trainer 100 may include a slot 150. The slot 150 may traverse or portion or an entirety of a width of injection trainer 100. For example, slot 150 may extend from a first side of muscle block 200 (e.g., where the top curved surface meets a first edge of the flat base) to a second side of muscle block 200 (e.g., where the top curved surface meets a second edge of the flat base). Slot 150 may also extend through surface layer 130 and intermediate layer 120, as shown in FIGS. 1A-1D. In some embodiments, the widths of intermediate layer 120 and surface layer 130 are short enough so as to not obstruct slot 150, without the slot 150 extending through intermediate layer 120 and surface layer 130. In some embodiments (e.g., those shown in FIGS. 3A-3D and 5A-5C, and described in greater detail below), the portion of slot 150 that extends through surface layer 130 and intermediate layer 120 has a height less than the height of the portion of slot 150 within muscle block 200. This height of the portion of slot 150 within surface layer 130 and intermediate layer 120 may be small enough to secure a fastening strap, as described below.

Although FIGS. 1A-1D show slot 150 extending the entire width of injection trainer 100, and in the middle of the length of injection trainer 100, this is only one example. Slot 150 may span a portion of the width of injection trainer 100, and may be located anywhere on the injection trainer 100, not just the middle of the length. In addition or alternatively, injection trainer 100 may include a slot 150 extending an entire length, or a portion of the length, of injection trainer 100. Moreover, injection trainer 100 may include multiple such slots 150 or other suitable features, as desired.

In embodiments where injection trainer 100 includes a slot 150, the slot 150 may be configured to interface with a base plate and/or a fastening strap. For example, the base plate and/or fastening strap may have one or more protrusions or members that engage with slot 150, and hold the injection trainer 100 in place, relative to the base plate. As shown in FIGS. 1A-1D, slot 150 may have a rectangular cross section and a consistent profile, across the entirety of slot 150. In other embodiments, the cross section of slot 150 may have another shape that allows it to interface with the base plate and/or a fastening strap. The dimensions of slot 150 may be consistent throughout the entirety of the slot 150, or may vary (e.g., the slot may get deeper, shallower, wider, or narrower from one terminus of the slot to the other terminus).

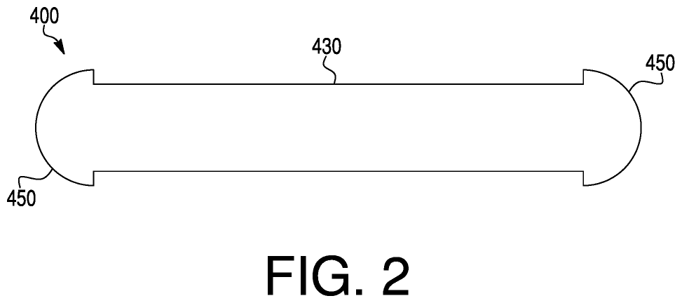

Injection trainer 100 may include a fastening strap 400. Referring to FIG. 2, fasting strap 400 may include a body 430 and one or more ends 450. The body 430 of fastening strap 400 may have sufficient length to extend from one end of the injection trainer 100 to an opposing end of the injection trainer 100.

The one or more ends 450 of the fastening strap 400 may have a shape that is configured to interact (e.g., interlock) with one or more components of base plate 500 and/or injection trainer 100. For example, a slot 150 through surface layer 130 and intermediate layer 120 may have dimensions that allow the ends 450 of fastening strap 400 to pass though the slot 150. The dimensions of the ends 450 may prevent them from easily passing through slot 150 in both directions, thereby retaining the fastening strap 400 within injection trainer 100, after fastening strap 400 has been inserted through slot 150. When fastening strap 400 is retained with injection trainer 100, at least a portion of the body 430 of fastening strap 400 may be disposed within the portion of slot 150 within muscle block 200.

For example, as shown in FIGS. 3A-3D, a first portion (e.g., an end 450) of fastening strap 400 may extend past a first exterior surface the injection trainer 100. A second portion (e.g., an end 450) of the fastening strap 400 that is opposite the first portion, may extend past a second exterior surface of the injection trainer 100. As shown in FIGS. 3A-3D, the first and exterior surfaces may be on opposing sides of injection trainer 100. A third portion of the fastening strap (e.g., a body 430), between the first portion and the second portion, may be disposed within slot 150.

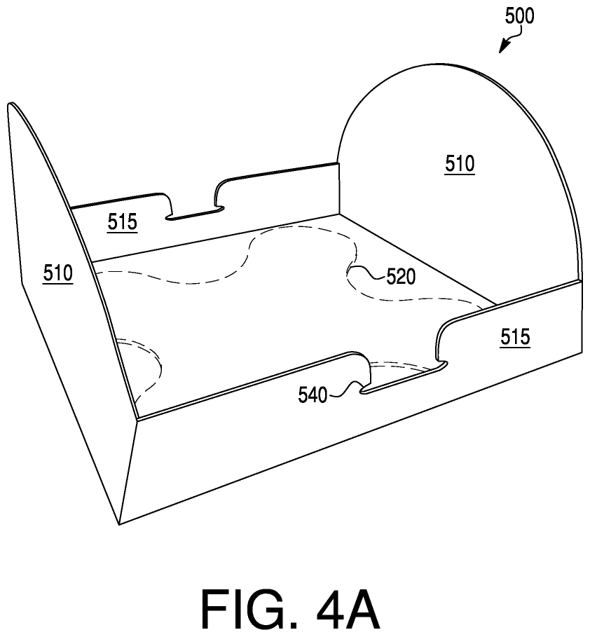

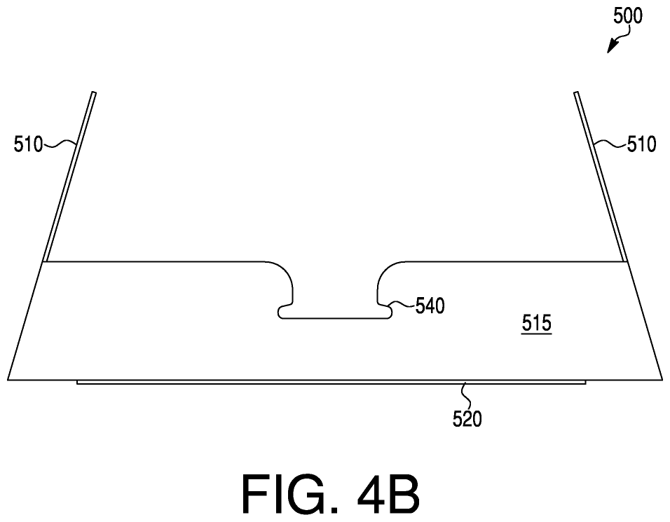

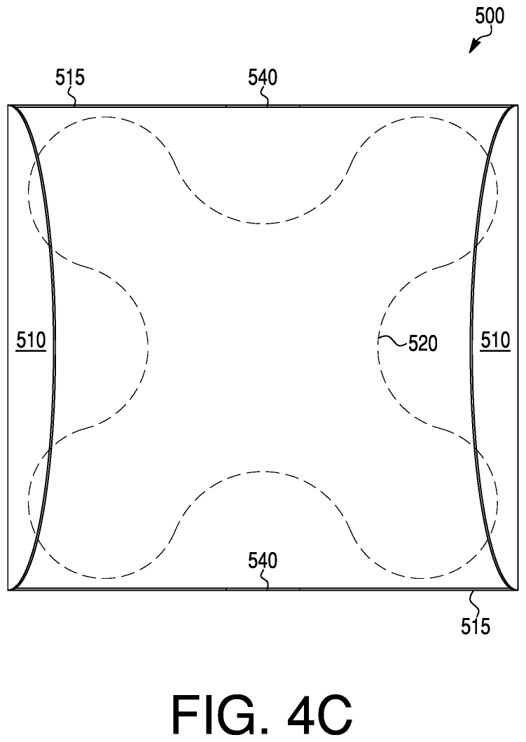

Injection trainer 100 may be configured to interface (e.g., interlock) with a base plate 500. Base plate 500 may include walls surrounding a bottom surface to support and maintain the shape of injection trainer 100. One or more walls of base plate 500 may include features configured to interface with fastening strap 400. Referring to FIGS. 4A-4C, in one example, base plate 500 may include two end walls 510 and two side walls 515. The dimensions of base plate 500 may be large enough that injection trainer 100 may be retained within the end walls 510 and side walls 515 of base plate 500. The end walls 510 may have a curvature that matches the curvature of the ends of injection trainer 100. The height and width of end walls 510 may be sufficient to cover the entire end surfaces of injection trainer 100. The height of side walls 515 may be sufficient to cover the edges of surface layer 130 and intermediate layer 120 and/or the interface of the overlying layers and muscle block 200.

In some embodiments, base plate 500 may be collapsible. Ends walls 510 and side walls 515 may fold down so that base plate 500 forms a planar shape. When end walls 510 and side walls 515 are raised at an angle to the bottom of base plate 500, features of end walls 510 may engage with features from side walls 515 to reinforce the three-dimensional shape of base plate 500.

In some embodiments, the bottom of base plate 500 includes a skid resistant region 520. Skid resistant region 520 may be provided as a separate structure on the bottom of base plate 500, or it may be incorporated into the bottom surface of base plate 500. The skid resistant region 520 may comprise any material that provides increased sliding friction and/or increased surface tack. Skid resistant region 520 may include any shape along the bottom surface of base plate 500 that provides increased sliding friction and/or increased surface tack.

In some embodiments, injection trainer 100 may interface with base plate 500 and fastening strap 400. One or more walls (e.g., side walls 515) of base plate 500 may include a retaining feature 540. The retaining feature 540 may be configured to receive fastening strap 400. For example, the width of body 430 of fastening strap 400 may be narrow enough to pass though retaining feature 540, while the width of an end 450 of fastening strap 400 is too large to pass through retaining feature 540. In this manner, retaining feature 540 may assist in securing injection trainer 100—including the muscle block 200, the overlying layers, and fastening strap 400—in position relative to base plate 500.

An exemplary injection trainer 100 including a fastening strap 400 and base plate 500 is shown in FIGS. 5A-5C. In the example shown in FIGS. 5A-5C, similar to the embodiments shown in FIGS. 3A-3D, surface layer 130 and intermediate layer 120 each may include a portion of slot 150 that has a smaller height than the portion of slot 150 within muscle block 200. In these examples, the portion of slot 150 within surface layer 130 may be surrounded by material of surface layer 130, and the portion of slot 150 within intermediate layer 120 may be surrounded by material of intermediate layer 120. The fastening strap 400 may pass from a first exterior surface of injection trainer 100, through slot 150 (including though a first portion of surface layer 130, through a first portion of intermediate layer 120, through muscle block 200, through a second portion of intermediate layer 120, and through a second portion of surface layer 130), and past a second exterior surface of injection trainer 100. As shown in FIGS. 5A-5C, the position of retaining features 540 may be configured to align with slot 150, when injection trainer 100 is within base plate 500. Engaging the fastening strap 400 with retaining features 540, after fastening strap is passed though slot 150, may provide additional securement of the injection trainer relative to base plate 500. In addition or alternatively, engaging fastening strap 400 with retaining features 540, after fastening strap is passed though slot 150, my provide additional securement of the overlying layers, relative to muscle block 200.

In some embodiments, base plate 500 may include one or more additional features that allow the base plate 500 to be secured to another surface. For example, after fastening strap 400 is engaged with retaining features 540, base plate 500 may engage with an additional strap or securement device. The additional strap or securement device may be affixed to a vertical surface, a limb, or other tissue, to more accurately simulate real-use scenario injections, during operation of injection trainer 100.

Muscle Block

As described above, injection trainer 100 includes a muscle block 200. The muscle block 200 may simulate the back pressure provided by muscle tissue when an injector (e.g., an auto-injector, wearable injector, pre-filled syringe, etc.) is pushed into the tissue (e.g., to trigger the injector). Muscle block 200 may be configured such that the back pressure provided by muscle block 200 may be consistent, regardless of the direction of the injection. Additionally, muscle block 200 may allow for fluid to pass through the muscle block. For example, medicament or other fluid delivered during injection may pass through tubules, pores, or other microstructures within muscle block 200. Similarly, during cleaning of the injection trainer 100, water or other cleaning fluid may pass through the microstructures of muscle block 200, allowing for an effective and efficient clean.

For example, referring to FIGS. 2A-2D, the general geometry of muscle block 200 may comprise a half cylinder, another shape with a flat surface opposite a curved surface, or another shape that approximates human tissue. Although these descriptions describe the general geometry of the muscle block 200, the material that constitutes the muscle block 200 may be arranged in a detailed pattern of fill material 225 and space 250. In this context, space 250 refers to the portions of the muscle block 200 between fill material 225, comprising, for example, air. Fill material 225 may comprise one or more flexible or semi-rigid polymers. For example, fill material 225 may comprise polylactic acid, polypropylene, polyethylene terephthalate, acrylonitrile butadiene styrene polymers, acrylic styrene acrylonitrile polymers, poly(methyl methacrylate), polyoxymethylene, polyetherimide, thermoplastic urethane, thermoplastic elastomers, flexible photopolymer resin (e.g., including acrylate monomers, urethane dimethacrylate, and/or isobornyl acrylate), other thermoplastic polymers, or other material capable of being used in an additive printing application.

The fill material 225 may have a Shore hardness of approximately 40 A to approximately 90 A, such as, for example, approximately 50 A to approximately 90 A, approximately 60 A to approximately 90 A, approximately 70 A to approximately 90 A, approximately 75 A to approximately 90 A, approximately 70 A to approximately 85 A, approximately 75 A to approximately 85 A, approximately 80 A to approximately 85 A, or approximately 80 A, as measured by ASTM D2240.

Referring again to the general geometry of the exemplary muscle block 200 shown in FIGS. 2A-2D, in embodiments where muscle block 200 approximates a portion of a limb (e.g., a leg), the muscle block 200 may have a length L of approximately 80 millimeters (mm) to approximately 150 mm, such as for example, approximately 90 mm to approximately 140 mm, approximately 100 mm to approximately 130 mm, approximately 110 mm to approximately 120 mm, approximately 80 mm to approximately 115 mm, approximately 115 mm to approximately 150 mm, greater than approximately 75 mm, less than approximately 160 mm, or approximately 115 mm. Muscle block 200 may have a width W of approximately 65 mm to approximately 105 mm, such as, for example, approximately 70 mm to approximately 95 mm, approximately 75 mm to approximately 90 mm, approximately 78 mm to approximately 85 mm, approximately 65 mm to approximately 85 mm, approximately 80 mm to approximately 105 mm, greater than approximately 60 mm, less than approximately 110 mm, or approximately 82 mm. Muscle block 200 may have a height H (e.g., the maximum distance between the top surface and the base of muscle block 200) of approximately 20 mm to approximately 70 mm, such as, for example, approximately 25 mm to approximately 60 mm, approximately 30 mm to approximately 55 mm, approximately 35 mm to approximately 45 mm, approximately 20 mm to approximately 45 mm, approximately 45 mm to approximately 70 mm, greater than approximately 15 mm, less than approximately 75 mm, or approximately 45 mm.

The dimensions of muscle block 200 may vary based on the intended application. For example, the ranges given relate to applications where muscle block 200 acts as an analog for a portion of a leg limb. In other embodiments, the general geometry, shape, and dimensions of muscle block 200 may be altered to act as a more accurate analog for other tissues and regions of tissue. For example, a smaller muscle block 200 may be provided to act as an analog for a portion of an arm limb. Large muscle blocks 200 may be provided as analogs for entire limbs or other regions of tissue.

The specific pattern of fill material 225 and space 250 within muscle block 200, may form the tubules, pores, channels, grooves, or other microstructures that allow fluid to pass through the muscle block. Depending on the pattern of fill material 225 and space 250, the microstructures may have straight features and consistent dimensions. In other embodiments, the walls of the microstructures are curved and the width or diameter of these features widens and narrows along the course of the microstructure. In one example, the microstructures of muscle block 200 may include channels or tubules that have a minimum width of approximately 2 mm to approximately 6 mm, such as, for example, approximately 4 mm.

As can be seen in FIGS. 2A-2D, the arrangement of fill material 225 and space 250 that constitutes muscle block 200 forms a repeating pattern. The arrangement of fill material 225 and space 250 may be defined by one or more unit cells (e.g., cubic unit cells). For example, a unit cell may be the smallest repeatable unit of a portion (e.g., a layer or a region) of muscle block 200. The unit cell includes three-dimensional arrangement of fill material 225 and space 250, capable of being repeated.

The surface of a unit cell defining a portion of muscle block 200 can be doubly periodic or triply periodic. For triply periodic unit cells, the dimensions of the unit cell may be cubic (e.g., the length, width, and height of the unit cell are equivalent). The length of such cubic unit cells may be approximately 4 mm to approximately 16 mm, such as, for example, less than or equal to approximately 16 mm, less than or equal to approximately 12 mm, less than or equal to approximately 10 mm, less than or equal to approximately 8 mm, approximately 4 mm to approximately 12 mm, approximately 4 mm to approximately 8 mm, approximately 6 mm to approximately 10 mm, or approximately 8 mm. For doubly periodic unit cells, the dimensions of the unit cell may be cubic (e.g., the length, width, and height of the unit cell are equivalent) or the dimensions of the unit cell may be rectangular (e.g., the length equal to the width, but not equal than the height). The length of such rectangular unit cells may be approximately 4 mm to approximately 16 mm, such as, for example, less than or equal to approximately 16 mm, less than or equal to approximately 12 mm, less than or equal to approximately 10 mm, less than or equal to approximately 8 mm, approximately 4 mm to approximately 12 mm, approximately 4 mm to approximately 8 mm, approximately 6 mm to approximately 10 mm, or approximately 8 mm; and the height of such rectangular unit cells may be approximately 4 mm to approximately 16 mm, such as, for example, less than or equal to approximately 16 mm, less than or equal to approximately 12 mm, less than or equal to approximately 10 mm, less than or equal to approximately 8 mm, approximately 4 mm to approximately 12 mm, approximately 4 mm to approximately 8 mm, approximately 6 mm to approximately 10 mm, or approximately 8 mm.

The arrangement of fill material 225 and space 250 that constitutes the muscle block 200 shown in FIGS. 2A-2D, is defined by a unit cell comprising a triply periodic surface. Specifically, in the embodiment shown in FIGS. 2A-2D, the arrangement of fill material 225 and space 250 that constitutes the muscle block 200 is defined by a gyroid shape repeating in three-dimensions.

During manufacture of muscle block 200, fill material 225 is formed in the shape of the periodic surface, and other fill material 225 is added to the formed fill material 225, also in the shape of the periodic surface. By repeating this unit cell defined pattern in two-dimensions or three-dimensions, as described herein, a muscle block 200 having the aforementioned advantageous properties may be formed. For example, the repeating shape of fill material 225 (e.g., gyroid shape) may contribute the isotropic reaction to externally applied forces exhibited by muscle block 200. Additionally, the repeating pattern of fill material 225 and space 250 (e.g., gyroid shape) may allow for fluid to pass through muscle block 200.

A portion of muscle block 200 may have an arrangement of fill material 225 and space 250 defined by the repeated arrangement of fill material 225 and space 250 in two dimensions, for example, a pattern of fill material 225 and space 250 defined by a unit cell may repeat along a length and a width of muscle block 200, along a length and a height of muscle block 200, or along a width and a height of muscle block 200, forming a layer (e.g., a vertical layer or horizontal layer) of muscle block 200. In addition, or alternatively, a portion of muscle block 200 may have an arrangement of fill material 225 and space 250 defined by the repeated arrangement of fill material 225 and space 250 in three dimensions, for example, a pattern of fill material 225 and spacer 250 defined by a unit cell may repeat along a length, a height, and width of muscle block 200.

In the embodiment, shown in FIGS. 2A-2D, the arrangement of fill material 225 and space 250 constituting muscle block 200 is defined by the unit cell 220 shown in FIGS. 3A-3D, repeating in three dimensions. Referring to FIGS. 3A-3D, the fill material 225 within the unit cell 220 is triply periodic, and repeats in three dimensions: lengthwise, width wise, and height wise. The shape of fill material 225 shown in the unit cell 220 is referred to as a gyroid, and when repeated in three dimensions it forms several tubules within muscle block 200. For example, the space 250 shown in FIGS. 3B-3D is within the tubules formed by the gyroid fill. In the example shown in FIGS. 2A-2D, the axes of the unit cell are aligned with the length, width, and height of the general geometry of muscle block 200. This is one example shown for clarity. In other embodiments, the unit cell may be skewed, yawed, tilted, pitched, and/or rolled, relative to the edges and surface of the general geometry of muscle block 200.

Although the unit cell 220 shown in FIGS. 3A-3D includes a gyroid shaped arrangement of fill material 225 and space 250, this is only one example. Muscle blocks 200, or portions of the muscle blocks 200, may be defined by a unit cell 220 including any doubly periodic or triply periodic arrangement of fill material 225 and space 250, such as, for example, linoloid shapes, catenoid shapes, helicoid shapes, or other Schwartz surfaces.

As previously alluded to, arrangements of fill material 225 and space 250 defined by a unit cell 220 may be repeated in two dimensions or in three dimensions. FIGS. 4A-4D show the unit cell 220 of FIGS. 3A-3D repeated in two dimensions within the same plane—length-wise and width-wise—to form a layer 240 of muscle block 200. Layers 240 may be combined to form the entirety of muscle block 200, or regions of muscle block 200. For example, horizontal layers 240 may be stacked on top of each other, or vertical layers 240 may be stacked next to each other, to form a three-dimensional region of muscle block 200. When layers 240 are combined to form a region of muscle block 200, the arrangement of fill material 225 and space 250 in the layers 240 may be defined by the same unit cell 220, or may be defined by different unit cells 220. For example, even if adjacent layers 240 are defined by different unit cells 220, tubules, channels, or other microstructures of the first layer 240, may align with microstructures of the second layer 240.

FIGS. 5A-5D show the unit cell 220 of FIGS. 3A-3D repeated in three dimensions—length-wise, width-wise, and height-wise, to form a region 330 of muscle block 200. The regions 300 of muscle block 200 defined by repeating unit cells 220 may be stacked next to each other, and or on top of each other, to form muscle block 200. Regions 330 or layers 240 defined by a unit cell 220 repeating in three dimensions or two dimensions may be positioned adjacent to regions 330 or layers 240 defined by the same unit cell 220, or a different unit cell 220. For example, even if adjacent layers 240 or regions 330 are defined by different unit cells 220, tubules, channels, or other microstructures of the first layer 240 or region 330, may align with microstructures of the second layer 240 or region 330.

Near the periphery of muscle block 200, around layers 240 defined by a repeating unit cell 220, and/or around regions defined by a unit cell 220, the repeating structure may be modified to accommodate the general geometry of muscle block 200 or to join microstructures of a first region or layer 240 with the microstructures of a second region or layer 240. The overall volume of muscle block 200 that is occupied by regions 330 or layers 240 defined by a repeating unit cell 220, may represent at least approximately 20% of the total volume of the muscle block 200. For example, the volume of muscle block 200 that is occupied by regions or layers 240 defined by one or more repeating unit cells 220, may represent at least approximately 40%, at least approximately 60%, at least approximately 75%, at least approximately 80%, at least approximately 85%, at least approximately 90%, at least approximately 95%, at least approximately 99%, approximately 50% to approximately 100%, approximately 75% to approximately 100%, approximately 85% to approximately 100%, or approximately 85% to 99% of the total volume of muscle block 200. In the calculation of the percentage of the muscle block 200 that is defined by a repeating unit cell, the volume occupied by slot 150 is not considered towards the total volume of muscle block 200.

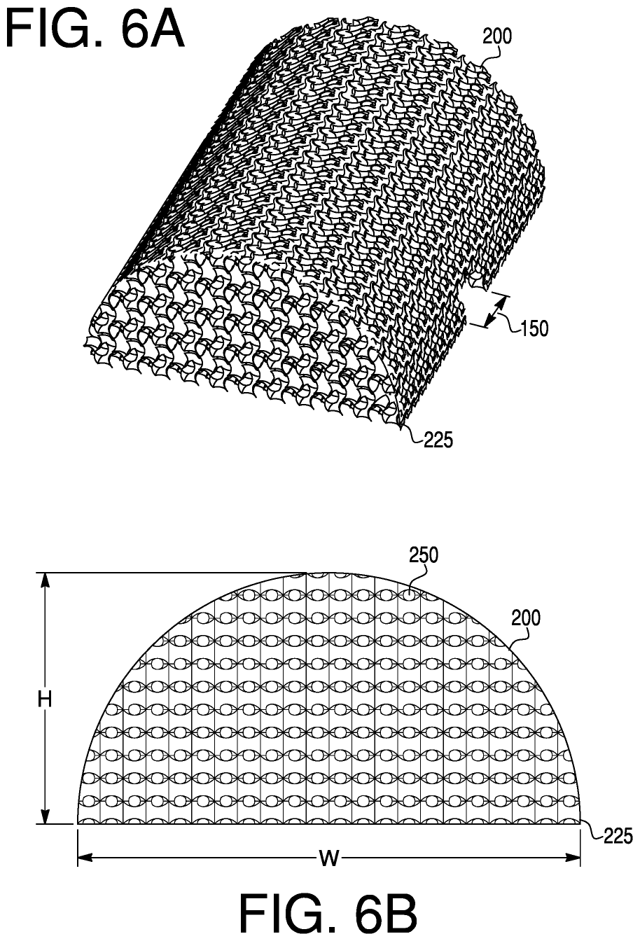

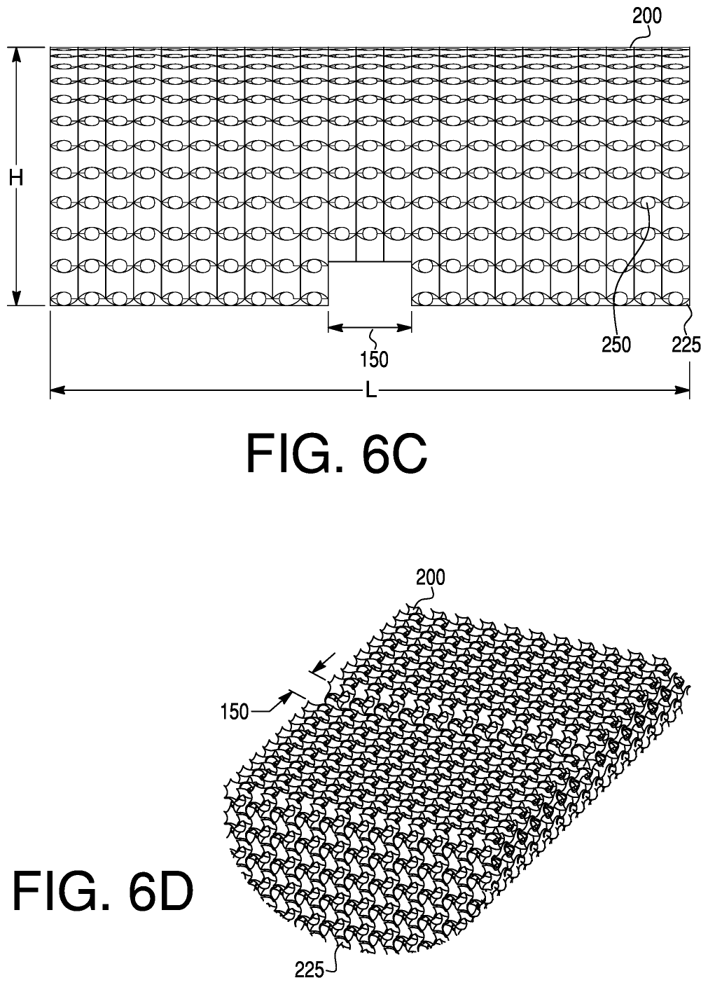

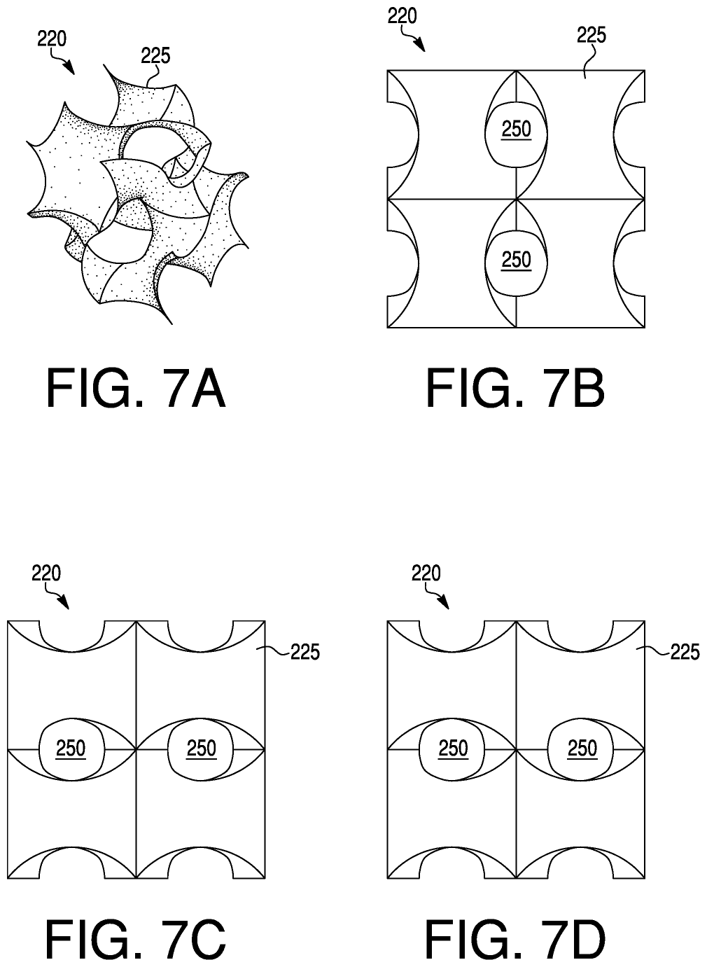

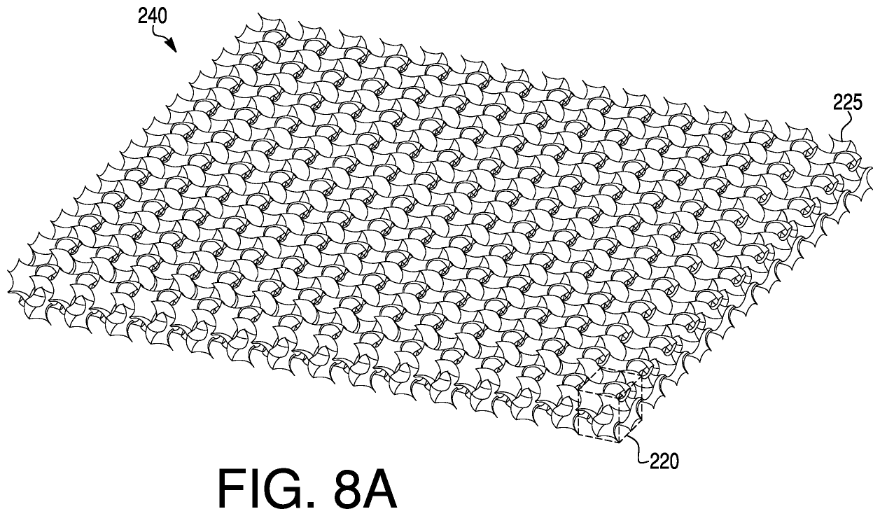

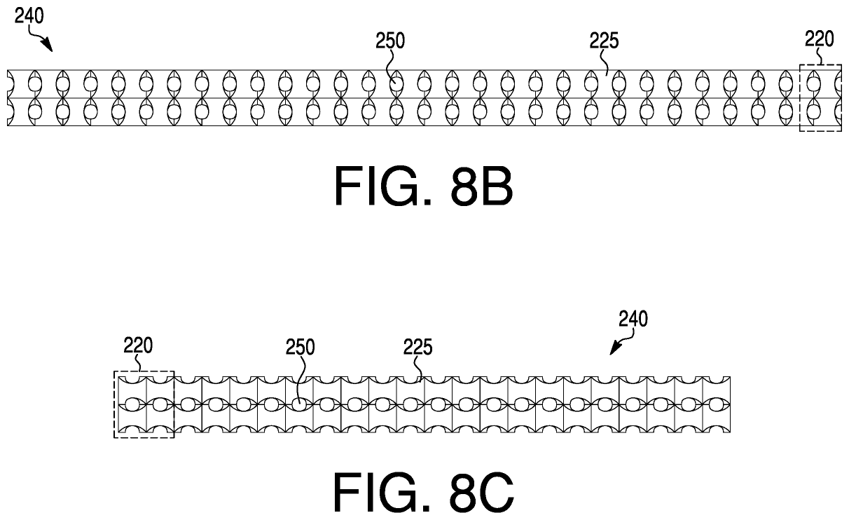

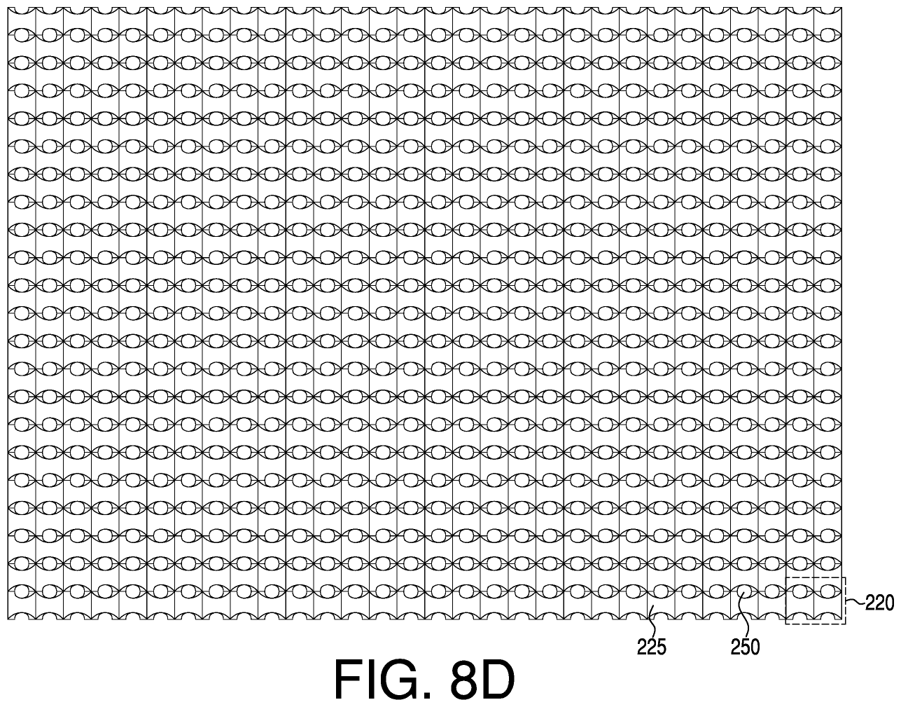

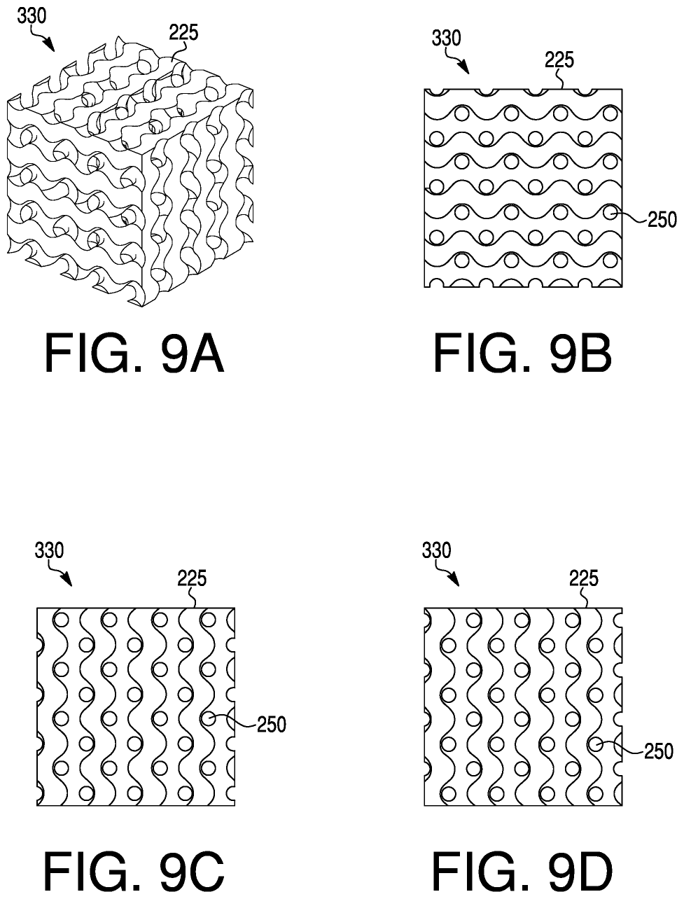

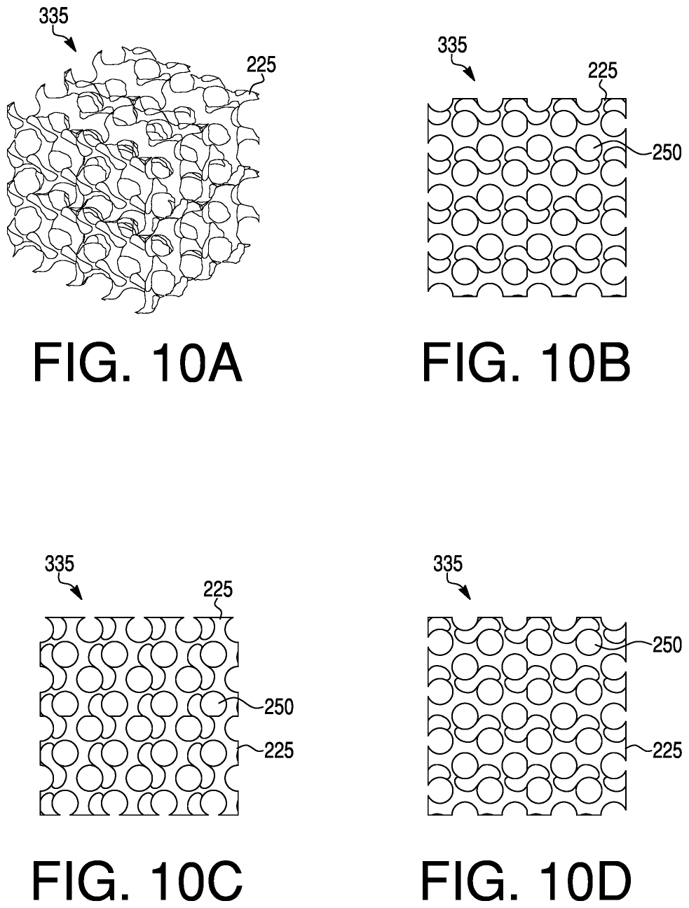

As previously described, the arrangement of fill material 225 and space 250 within muscle block 200 may be designed to approximate the back pressure provided by muscle tissue. In addition to altering the arrangement of fill material 225, as defined by periodic shapes within a unit cell 220, the percentage of fill according to those shapes may also be adjusted. For example, for a given periodic shape, several different densities of that shape may be defined within a unit cell. The density of the fill material 225 within a region 330 of muscle block may be calculated as percentage infill, where the volume of fill material 225 in a given region (e.g., in a unit cell 220) is taken as a percentage of the total volume of the given region. The fill material 225 and space 250 of the region 330 of muscle block 200 shown in FIGS. 5A-5D is arranged according to a unit cell 220 including a gyroid shape and 20% infill. The percentage infill may be increased by adding more fill material 225, in place of space 250, according to the periodic shape. Similarly, the percentage infill may be decreased by removing fill material, to increase space 250, according to the periodic shape. FIGS. 6A-6D show a region 335 of muscle block 200 defined by a unit cell 220 including a gyroid shape, but with 10% infill. The reduced percentage infill results in more space 250 and less fill material 225 within the region 335 of muscle block 200.

The percentage infill may be adjusted based on the properties of the tissue being analogized by muscle block 200. For example, stiffer and more resilient tissue may be approximated by an increased infill percentage. Further, if the composition of fill material 225 is adjusted to result in fill material 225 with altered stiffness, flexibility, or other properties that affect the back pressure provided by muscle block 200, the infill percentage may be adjusted so that the muscle block 200 provides the requisite back pressure and exhibits the requisite flexibility.

The average density of muscle block 200 (e.g., the average infill percentage of the regions of muscle block 200 defined by one or more repeating unit cells) may be approximately 5% infill to approximately 50% infill, such as, for example, approximately 5% infill to approximately 40% infill, approximately 5% infill to approximately 25% infill, approximately 5% infill to approximately 20% infill, approximately 5% infill to approximately 15% infill, approximately 10% infill to approximately 25% infill, approximately 10% infill to approximately 20% infill, or approximately 15% infill.

In some embodiments, a first region of muscle block 200 may have different infill percentage than a second region of muscle block 200, in order to create a specific force profile for muscle block 200. In addition, or alternatively, each region of muscle block 200 defined by a repeating unit cell has the same infill percentage.

The present disclosure is further described by the following non-limiting items.

Item 1. A muscle block comprising:

a plurality of first layers, wherein each first layer of the plurality of first layers comprises an arrangement of fill material defined by a first unit cell repeating in two dimensions within a plane;

a plurality of second layers, wherein each second layer of the plurality of second layers comprises an arrangement of fill material defined by a second unit cell repeating in two dimensions within a plane;

wherein the first unit cell comprises a doubly periodic or triply periodic arrangement of fill material; and

the second unit cell comprises a doubly periodic or triply periodic arrangement of fill material.

Item 2. The muscle block of item 1, wherein the first unit cell comprises a triply periodic arrangement of fill material including a gyroid shape.

Item 3. The muscle block of item 2, wherein the second unit cell is identical to the first unit cell.

Item 4. The muscle block of item 1, wherein the muscle block has a general geometry that includes a half cylinder.

Item 5. The muscle block of item 1, wherein the fill material comprises polylactic acid, polypropylene, polyethylene terephthalate, acrylonitrile butadiene styrene polymers, acrylic styrene acrylonitrile polymers, poly(methyl methacrylate), polyoxymethylene, polyetherimide, one or more other thermoplastic polymers, or other material capable of being used in an additive printing application.

Item 6. The muscle block of item 1, wherein a Shore hardness of the fill material is approximately 70 A to approximately 90 A.

Item 7. The muscle block of item 1, wherein an average density of the muscle block is approximately 10% infill to approximately 25% infill.

Item 8. The muscle block of item 1, wherein the first unit cell is a cubic unit cell and has a length of approximately 4 mm to approximately 12 mm.

Item 9. The muscle block of item 1, wherein the muscle block comprises tubules with a minimum diameter of approximately 2 mm to approximately 8 mm.

Item 10. An injection trainer comprising:

a muscle block; and

one or more overlying layers above the muscle block;

wherein a region of the muscle block comprises an arrangement of fill material defined by a unit cell repeating in three dimensions.

Item 11. The injection trainer of item 10, wherein the one or more overlying layers are designed to allow a user to simulate a skin pinch.

Item 12. The injection trainer of item 10, wherein the one or more overlying layers comprise an intermediate layer and a surface layer.

Item 13. The injection trainer of item 12, wherein the intermediate layer comprises a foam rubber, a polyurethane, or a sponge.

Item 14. The injection trainer of item 12, wherein the surface layer comprises a silicone rubber, an ethylene propylene rubber, a fluoroelastomer, an olefin-based rubber, a latex rubber, a nitrile rubber, or a butyl rubber.

Item 15. The injection trainer of item 10, wherein the fill material comprises polylactic acid, polypropylene, polyethylene terephthalate, acrylonitrile butadiene styrene polymers, acrylic styrene acrylonitrile polymers, poly(methyl methacrylate), polyoxymethylene, polyetherimide, one or more other thermoplastic polymers, or other material capable of being used in an additive printing application, and has a Shore hardness of approximately 70 A to approximately 90 A.

Item 16. The injection trainer of item 10, wherein the region of the muscle block comprises at least 80% of a total volume of the muscle block.

Item 17. An injection trainer comprising:

a muscle block comprising a material with a Shore hardness of approximately 70 A to approximately 90 A;

a surface layer comprising a silicone rubber, an ethylene propylene rubber, a fluoroelastomer, an olefin-based rubber, a latex rubber, a nitrile rubber, or a butyl rubber; and

an intermediate layer between the muscle block and the surface layer;

wherein the muscle block includes a region comprising an arrangement of fill material defined by a first unit cell repeating in three dimensions, and wherein the unit cell has a density of at least approximately 10% infill.

Item 18. The injection trainer of item 17, wherein the intermediate layer contacts the muscle block and the surface layer, and the intermediate layer comprises a foam rubber, a polyurethane, or a sponge.

Item 19. The injection trainer of item 17, wherein the combined thicknesses of the surface layer and the intermediate layer is less than or equal to the height of the muscle block.

Item 20. The injection trainer of item 17, further comprising a slot configured to interface with a base plate.

Those skilled in the art will appreciate that the conception upon which this disclosure is based may readily be used as a basis for designing other devices and systems for carrying out the several purposes of the present disclosure. Accordingly, the claims are not to be considered as limited by the foregoing description.

What is claimed is:

1. A muscle block comprising:
a plurality of first layers, wherein each first layer of the plurality of first layers comprises an arrangement of fill material defined by a first unit cell repeating in two dimensions within a plane;
a plurality of second layers, wherein each second layer of the plurality of second layers comprises an arrangement of fill material defined by a second unit cell repeating in two dimensions within a plane;
wherein the first unit cell comprises a doubly periodic or triply periodic arrangement of fill material; and
the second unit cell comprises a doubly periodic or triply periodic arrangement of fill material.

2. The muscle block of claim 1, wherein the first unit cell comprises a triply periodic arrangement of fill material including a gyroid shape.

3. The muscle block of claim 2, wherein the second unit cell is identical to the first unit cell.

4. The muscle block of claim 1, wherein the muscle block has a general geometry that includes a half cylinder.

5. The muscle block of claim 1, wherein the fill material comprises polylactic acid, polypropylene, polyethylene terephthalate, acrylonitrile butadiene styrene polymers, acrylic styrene acrylonitrile polymers, poly(methyl methacrylate), polyoxymethylene, polyetherimide, one or more other thermoplastic polymers, or other material capable of being used in an additive printing application.

6. The muscle block of claim 1, wherein a Shore hardness of the fill material is approximately 70 A to approximately 90 A.

7. The muscle block of claim 1, wherein an average density of the muscle block is approximately 10% infill to approximately 25% infill.

8. The muscle block of claim 1, wherein the first unit cell is a cubic unit cell and has a length of approximately 4 mm to approximately 12 mm.

9. The muscle block of claim 1, wherein the muscle block comprises tubules with a minimum diameter of approximately 2 mm to approximately 8 mm.

10. An injection trainer comprising:
a muscle block; and
one or more overlying layers above the muscle block;
wherein a region of the muscle block comprises an arrangement of fill material defined by a unit cell repeating in three dimensions.

11. The injection trainer of claim 10, wherein the one or more overlying layers are designed to allow a user to simulate a skin pinch.

12. The injection trainer of claim 10, wherein the one or more overlying layers comprise an intermediate layer and a surface layer.

13. The injection trainer of claim 12, wherein the intermediate layer comprises a foam rubber, a polyurethane, or a sponge.

14. The injection trainer of claim 12, wherein the surface layer comprises a silicone rubber, an ethylene propylene rubber, a fluoroelastomer, an olefin-based rubber, a latex rubber, a nitrile rubber, or a butyl rubber.

15. The injection trainer of claim 10, wherein the fill material comprises polylactic acid, polypropylene, polyethylene terephthalate, acrylonitrile butadiene styrene polymers, acrylic styrene acrylonitrile polymers, poly(methyl methacrylate), polyoxymethylene, polyetherimide, one or more other thermoplastic polymers, or other material capable of being used in an additive printing application, and has a Shore hardness of approximately 70 A to approximately 90 A.

16. The injection trainer of claim 10, wherein the region of the muscle block comprises at least 80% of a total volume of the muscle block.

17. An injection trainer comprising:
a muscle block comprising a material with a Shore hardness of approximately 70 A to approximately 90 A;
a surface layer comprising a silicone rubber, an ethylene propylene rubber, a fluoroelastomer, an olefin-based rubber, a latex rubber, a nitrile rubber, or a butyl rubber; and
an intermediate layer between the muscle block and the surface layer;
wherein the muscle block includes a region comprising an arrangement of fill material defined by a first unit cell repeating in three dimensions, and wherein the unit cell has a density of at least approximately 10% infill.

18. The injection trainer of claim 17, wherein the intermediate layer contacts the muscle block and the surface layer, and the intermediate layer comprises a foam rubber, a polyurethane, or a sponge.

19. The injection trainer of claim 17, wherein the combined thicknesses of the surface layer and the intermediate layer is less than or equal to the height of the muscle block.

20. The injection trainer of claim 17, further comprising a slot configured to interface with a base plate.
